(19) United States
(12) Patent Application Publication
(10) Pub. No.: US 2012/0211484 A1
(43) Pub. Date: Aug. 23, 2012

(54) METHODS AND APPARATUS FOR A MULTI-ZONE PEDESTAL HEATER

(75) Inventors: Jianhua Zhou, San Jose, CA (US); Juan Carlos Rocha-Alvarez, San Carlos, CA (US)

(73) Assignee: Applied Materials, Inc., Santa Clara, CA (US)

(21) Appl. No.: 13/033,592

(22) Filed: Feb. 23, 2011

(51) Int. Cl. H05B 3/68; H01C 17/02

(52) U.S. Cl. 219/448.11; 29/611

(57) ABSTRACT

The present invention provides systems, methods and apparatus for manufacturing a multi-zone pedestal heater. A multi-zone pedestal heater includes a heater plate which includes a first zone including a first heating element and a first thermocouple for sensing the temperature of the first zone wherein the first zone is disposed in the center of the heater plate; and a second zone including a second heating element and a first embedded thermocouple for sensing the temperature of the second zone wherein the first embedded thermocouple includes a first longitudinal piece that extends from a center of the heater plate to the second zone and the first longitudinal piece is entirely encased within the heater plate. Numerous additional aspects are disclosed.

### FIELD OF THE INVENTION

The present invention relates to susceptor pedestals for electronic device processing chambers, and more particularly to methods and apparatus for embedded multi-zone heaters in susceptor pedestals.

### BACKGROUND

A pedestal heater provides thermal control over a substrate during processing and is used as a moving stage to adjust the position of the substrate in an evacuated chamber. FIG. 1 illustrates a schematic representation of a conventional single-zone pedestal heater assembly. A conventional pedestal heater 100, made of either a metal, such as stainless steel or aluminum, or a ceramic such as aluminum nitride, includes a horizontal plate 102 in which a heating element 104, used as a heat source, is included, and a vertical shaft 106 attached to the bottom center of the plate 102. The temperature of such a single-zone pedestal heater 100 is usually measured and controlled by a thermocouple 108 that is in contact with the plate 102. The shaft 106 provides support to the heater plate 102 and makes it possible to raise and lower the heater plate 102 within the processing chamber 110. The shaft 106 also serves as a path through which terminals of the heating element 104 and the thermocouple 108 connect outside the vacuum chamber 110. Semiconductor processes are usually very sensitive to the temperature uniformity or profile of the pedestal heaters 100. An ideal temperature uniformity or profile may be achieved by careful design of the heating element 104 under certain conditions such as temperature set point, chamber pressure, gas flow rate, etc. However, actual conditions during semiconductor processes often deviate from the design condition and, as a result, the ideal uniform temperature profile cannot be maintained. In other words, single-zone heaters do not have sufficient adjustability to maintain a uniform temperature profile. Thus, what is needed are improved methods and apparatus for pedestal heaters that allow a more uniform temperature profile to be maintained.

### SUMMARY

In some embodiments, the present invention provides an embedded multi-zone pedestal heater for a processing chamber. The multi-zone pedestal heater includes a heater plate including a first zone including a first heating element and a first thermocouple for sensing the temperature of the first zone wherein the first zone is disposed in the center of the heater plate; and a second zone including a second heating element and a first embedded thermocouple for sensing the temperature of the second zone wherein the first embedded thermocouple includes a first longitudinal piece that extends from a center of the heater plate to the second zone and the first longitudinal piece is entirely encased within the heater plate.

In some other embodiments, the present invention provides a multi-zone a heater plate for a pedestal heater useable in a semiconductor processing chamber. The heater plate includes a first zone including a first heating element and a first thermocouple for sensing the temperature of the first zone wherein the first zone is disposed in the center of the heater plate; and a second zone including a second heating element and a first embedded thermocouple for sensing the temperature of the second zone wherein the first embedded thermocouple includes a first longitudinal piece that extends from a center of the heater plate to the second zone and the first longitudinal piece is entirely encased within the heater plate.

In yet other embodiments, the present invention provides a method of manufacturing a multi-zone pedestal heater for a processing chamber. The method includes forming a heater plate including a first zone including a first heating element and a first thermocouple for sensing the temperature of the first zone wherein the first zone is disposed in the center of the heater plate; and a second zone including a second heating element and a first embedded thermocouple for sensing the temperature of the second zone wherein the first embedded thermocouple includes a first longitudinal piece that extends from a center of the heater plate to the second zone and the first longitudinal piece is entirely encased within the heater plate.

### BRIEF DESCRIPTION OF THE DRAWINGS

Features of the present invention can be more clearly understood from the following detailed description considered in conjunction with the following drawings, in which the same reference numerals denote the same elements throughout.

FIG. 1 depicts a schematic representation of a conventional single zone pedestal heater assembly in a processing chamber according to the prior art.

FIG. 2 depicts a schematic representation of a conventional dual zone pedestal heater assembly in a processing chamber according to the prior art.

FIG. 3 depicts an inverted schematic representation of a multi-zone heater plate according to embodiments of the present invention.

FIG. 4 depicts an inverted schematic representation of multi-zone heater pedestal assembly according to embodiments of the present invention.

FIG. 5 depicts a schematic representation of a multi-zone heater pedestal assembly in a processing chamber according to embodiments of the present invention.

FIG. 6 is a flow chart depicting an example embodiment of a method of making a multi-zone pedestal heater assembly for a processing chamber according to the present invention.

FIG. 7 depicts a schematic representation of a multi-zone pedestal heater assembly in a processing chamber according to alternative embodiments of the present invention.

### DETAILED DESCRIPTION

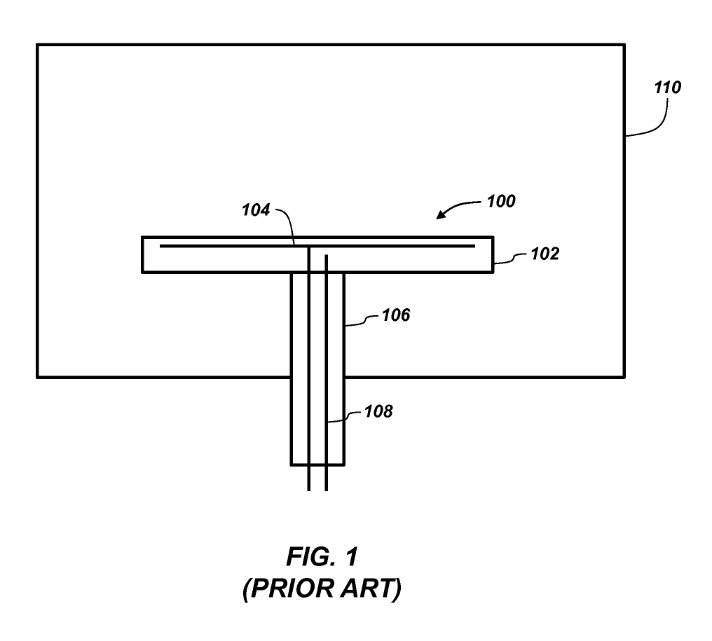

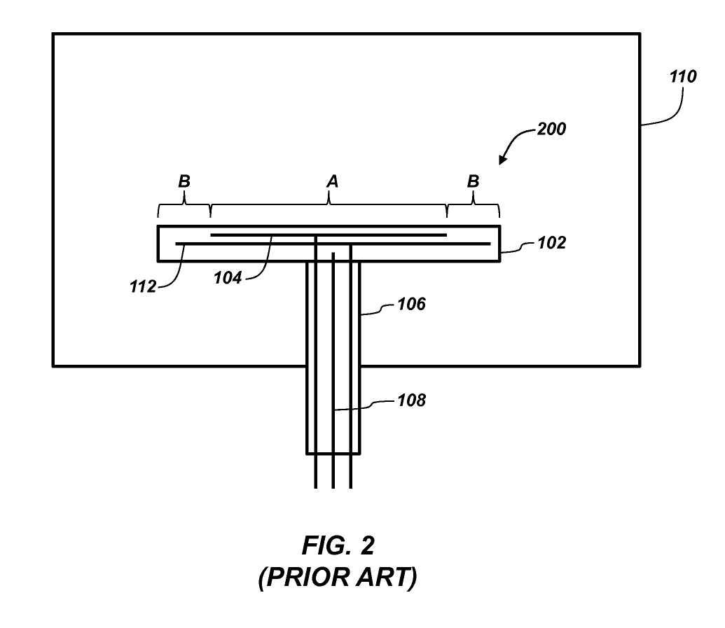

The present invention provides methods and apparatus for an improved pedestal heater assembly for a substrate processing chamber. In part, the adjustability problem described above with respect to the conventional pedestal heater shown in FIG. 1 may be solved using a dual-zone pedestal heater 200 in which two heating elements 104, 112 are embedded in the heater plate 102 to supply heat power either at a different rate or into different areas A, B of the plate 102 as shown in FIG. 2. More specifically, a dual-zone heater 200 with a heating element layout wherein element 104 creates an inner zone A and heating element 112 creates an outer zone B is depicted. The heater temperature uniformity or profile is adjustable based on the ratio of power directed to the two different zones.

However, it is difficult to precisely control the temperature of dual-zone pedestal heaters 200 in semiconductor chambers 110, especially those operated at high temperatures. Accurate temperature control requires reliable temperature measurement in each zone A, B of the heater 200. The inner zone A temperature of a dual-zone pedestal heater 200 may be measured by inserting a conventional thermocouple 108 through the shaft 106 on the bottom center of the heater 200 in the same way the temperature of a single-zone heater 100 is measured. However, for measuring the temperature of the outer zone B, this method is not viable since a shaft cannot be coupled below zone B due to thermal expansion concerns.

Other known temperature measurement techniques such as optical measurements utilizing light pipes or pyrometers and TCR (temperature coefficient of resistance) based measurement may be useful for non-production characterization but may not be suitable or reliable used in a high temperature semiconductor production process environment.

In the case of optical temperature measurement methods, it is difficult to layout pyrometers or light pipes within a processing chamber 110 so that semiconductor process (e.g., deposition or etching) is not disturbed. Further, the measurement results are altered when the to-be-measured surface and/or sensor windows are coated with residue during the semiconductor processing. Finally, optical sensors and a suitable controller are expensive and may not be cost effective.

Regarding TCR measurement methods, since the heating element resistance is a function of temperature, an initial characterization of the heating element is typically required to determine a TCR curve. During semiconductor processes, the heater temperatures may be calculated based on heater resistance values through interpolation. However, the TCR method will not be feasible if the heating element does not exhibit a detectable resistance variation with temperature variations. On the other hand, even if the TCR of the heating element is measureable, the characterization of TCR is heater dependent and time consuming. Since the temperature of the heating element is thus difficult to measure, the TCR curve actually correlates the heater resistance to temperatures on surrounding media such as heater surfaces or wafers. This indirect relationship between heater resistance and heater temperature further reduces the reliability and accuracy of the TCR measurement method.

The present invention provides improved methods and apparatus for accurately measuring the heater plate temperatures within different zones of a multi-zone pedestal heater assembly. By incorporating an embedded thermocouple into each zone of a multi-zone pedestal heater assembly, the present invention enables maintaining a uniform temperature profile across the heater plate. Based on the temperature information measured via the thermocouple in each zone, the power supplied to each zone's heating element can be adjusted to maintain the desired heater plate temperature profile across all the zones.

Many materials present a voltage drop across their opposite ends if there exists a temperature difference across the material. This property is known as the Seebeck effect. The ratio of the voltage drop (delta_V) to the temperature difference (delta_T) is referred to as Seebeck coefficient and may be quantified in units of microns V/degree C. The Seebeck coefficient is dependent on the material itself. A conventional thermocouple utilizes the Seebeck effect of materials to measure temperature difference between a junction point and a reference point, where the reference point is typically relatively far away from the junction point. Lengths of two different materials with different Seebeck coefficients are coupled at the junction point and the voltage drop between the two materials at the reference point (e.g., at the opposite end from the junction point) is measured. The measured voltage drop corresponds to the temperature at the junction point.

It is desirable that the two materials that are used to form a thermocouple should have different Seebeck coefficients. To make a sensitive thermocouple adapted for use in a heater pedestal according to the present invention, materials are selected that have a Seebeck coefficient difference as large as possible. Thereby, even a small temperature difference will be converted to a detectable voltage signal that may be measured and recorded. Commercially available thermocouples have Seebeck coefficient differences ranging from about 10 micron V/degree C. (Type B, R and S) to about 70 micron V/degree C. (Type E). However, these thermocouples may not be suitable for embedding into a pedestal heater plate or for use in high temperature applications.

According to the present invention, the materials selected to form an embedded thermocouple for a pedestal heater have (1) a melting point high enough to not be damaged during the manufacturing process; (2) Seebeck coefficient difference sufficient to generate a voltage signal corresponding to small temperature variations that effect semiconductor manufacturing processes; and (3) a coefficient of thermal expansion close enough to the coefficient of thermal expansion of the heater plate so that neither the heater plate nor the thermocouple are damaged due to expansion when exposed to process temperatures.

For example, the materials selected for use as an embedded thermocouple in a heater plate manufactured using sintering, should have a melting point greater than approximately 2000 C to 2400 C which is a typical temperature range at which sintering may be performed. Other manufacturing processes which can be used, may have higher or lower temperatures in which case thermocouple materials with correspondingly higher or lower melting points may be employed.

The materials selected for use as an embedded thermocouple should also have a Seebeck coefficient difference sufficient to detect an approximately 0.5 degree C. temperature variation. For example, a coefficient difference greater than approximately 15 micron V/degree C. would generate a detectable electrical signal. Some semiconductor processes may require smaller or allow larger temperature variations and thus, correspondingly larger or smaller coefficient differences may be required or allowed.

Depending on how ductile the heater plate is, the materials selected for use as an embedded thermocouple would desirably have a thermal expansion rate within approximately 0.5e-4% or 0.5e-6 in/in C of the material used for the heater plate, for typical heater plate materials. In other embodiments and/or using other materials, other ranges may be used.

Examples of materials for the thermocouple that meet the above criteria for use in a heater plate made of, for example, aluminum nitride (ALN), include tungsten-5% rhenium alloy (W5Re) and tungsten-26% rhenium alloy (W26Re). These two materials have melting points above 3000 C, a Seebeck coefficient difference of 19 micron V/degree C., and thermal expansion rate of about 5.6e-6 in/in C. AlN has a thermal expansion rate of approximately 5.4e-6 in/in C which means the thermal expansion rate of the thermocouple is within 0.2e-6 in/in C of the thermal expansion rate of the heater plate. A thermocouple made from W5Re and W26Re can be used to measure temperatures up to approximately 2000 C. In some embodiments, other materials such as aluminum and stainless steel may be used to form the heater plate and thus, different materials for the thermocouple that meet the above criteria may be used.

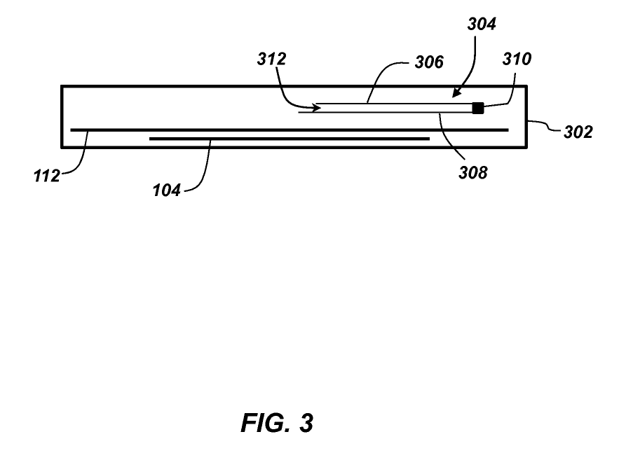

Turning to FIG. 3, a heater plate 302 with an embedded thermocouple 304 is depicted. Note that the heater plate 302 is shown inverted from the orientation in which it would typically be used in a processing chamber. In some embodiments, during manufacturing, the heater plate 302 may be formed using a hot press sintering process in which AlN in powder form may be pressed into a mold and heated. In a simplified example embodiment, the heater plate 302 may be formed by layering AlN powder into the mold, positioning the first heating element 104 on the first layer of AlN, depositing a second layer of AlN powder over the first heating element 104, positioning the second heating element 112 on the second layer of AlN powder, adding a third layer of AlN powder over the second heating element 112, positioning the thermocouple 304 on the third layer of AlN, and then depositing a fourth layer of AlN powder over the thermocouple 304. Once the layers of AlN powder, the elements 104, 112, and the thermocouple 304 are in place, high pressure and high temperature (as are known in the art) may be applied to the structure to induce sintering. The result is the formation of a solid heating plate 302 as shown in FIG. 3. Note that the above example describes steps for forming a two zone heater plate. In other embodiments, 3, 4, 5, and 6 or more zone heater plates may be made with appropriate corresponding layering steps and additional heating elements and thermocouples.

In some embodiments, the thermocouple 304 of the present invention includes a longitudinal piece of a first material 306 and a longitudinal piece of a second material 308. In addition to having the characteristics described above with respect to (1) a melting point, (2) Seebeck coefficient difference, and (3) coefficient of thermal expansion, the materials chosen for the longitudinal pieces 306, 308 may be shaped in bars, wires, strips, or any other practicable shape that can both extend radially from the center of the heater plate 302 to an outer heating zone of the heater plate 302 and also have sufficient surface area at both ends to allow formation of reliable electrical connections. At the junction end 310 of the longitudinal pieces 306, 308, the longitudinal pieces 306, 308 may be welded together and/or otherwise connected using a conductive filler material.

In embodiments where the thermocouple junction 310 is formed by welding, a welding method should be chosen which would allow the junction 310 to remain intact and tolerate the heat applied during the sintering process. For example, tungsten inert gas (TIG) welding or similar techniques may be used to weld a piece of W5Re, W26Re or other conductive materials to the W5Re and W26Re longitudinal pieces 306, 308 to form welding junctions that will not melt during sintering.

Thus, in some embodiments, a method of forming the thermocouple junction 310 is to sandwich a filler material between W5Re and W26Re strips which function as the longitudinal pieces 306, 308. The filler material may be a metal with resistivity not higher than either W5Re or W26Re and have a melting point above sintering temperatures. Examples of suitable filler materials for use with W5Re and W26Re strips used as the longitudinal pieces 306, 308 include W5Re, W26Re, tungsten (W), molybdenum (Mo), and similar materials. In some embodiments, the hot press sintering process could be used to bond the filler material to the W5Re and W26Re longitudinal pieces 306, 308.

An insulating material may be inserted in the space 312 between the longitudinal pieces 306, 308 or the AlN powder may be forced into the space 312 between the pieces 306, 308. If AlN is used to insulate the thermocouple pieces 306, 308 from each other, a minimum thickness of AlN that is approximately at least 0.5 mm may be sufficient. Additional thickness may be used. Note that although the longitudinal pieces 306, 308 shown in FIG. 3 are disposed one over the other, in other embodiments, the longitudinal pieces 306, 308 may be spaced lateral to each other and thus, be disposed at the same vertical position within the heater plate. Such an arrangement may facilitate more easily and reliably depositing insulating AlN powder into the space 312 between the pieces 306, 308 during manufacturing.

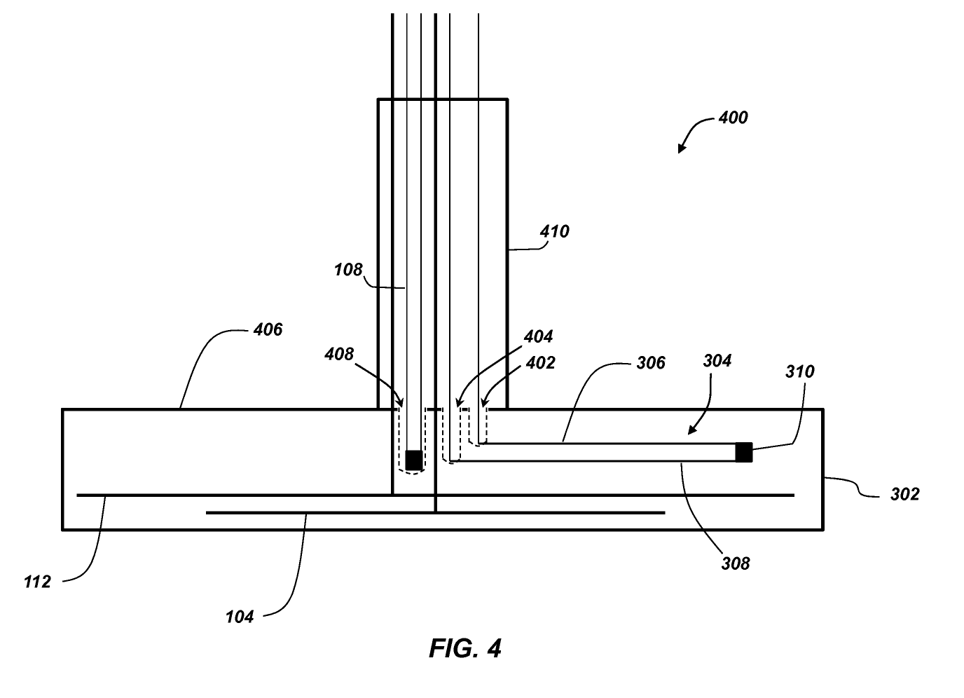

Turing now to FIG. 4, the remaining steps of forming an example embodiment of multi-zone heater pedestal heater 400 according to the present invention are described. After sintering the heater plate 302, holes 402, 404 are opened in the center of the lower surface 406 of the plate 302. Note again that as in FIG. 3, the heater pedestal 400 in FIG. 4 is shown inverted relative to its normal operating orientation in a processing chamber. Holes 402, 404 extend down to expose the longitudinal pieces 306, 308. Any practicable method (e.g., drilling) of opening a hole in the heater plate 302 may be used. The holes 402, 404 are made of sufficient diameter to allow connectors (e.g., conductive wires) to be connected to the longitudinal pieces 306, 308. In some embodiments, the same materials used for the longitudinal pieces 306, 308 may be used for the connectors, respectively. In some embodiments, the connectors are a different material that the longitudinal pieces 306, 308. In such a case, the measured temperature will be based on the temperature difference between the thermocouple junction 310 location and the connector connection points in the center of the heater plate 302. For a dual-zone heater, the connector connection points are proximate to a conventional thermocouple 108 used to measure the temperature of the inner zone and which is disposed at the center of the heater plate 302. Assuming the temperature of the connector connection points is the same as the temperature of the inner zone, the temperature at the thermocouple junction 310 location can be calculated.

In some embodiments, the connectors are brazed, welded, or soldered to the longitudinal pieces 306, 308. The brazing process may be performed in an oxygen free environment to avoid oxidation of the materials. In addition, a hole 408 may be opened to insert the conventional thermocouple 108 into the heater plate 302 for the inner heating zone A (FIG. 2). Note that although not shown, additional holes for connectors to the heating elements 104, 112 may also be opened and the connections to the elements 104, 112 may be made.

The shaft 410 may next be attached to the in the center of the lower surface 406 of the heater plate 302. In some embodiments, the shaft 410, which houses the connectors to the longitudinal pieces 306, 308, a connector to the conventional thermocouple 108, and connectors to the heating elements, 104, 112, may be attached to the heater plate 302 before the various connectors are attached to the respective thermocouples 108, 304 and heater elements 104, 112.

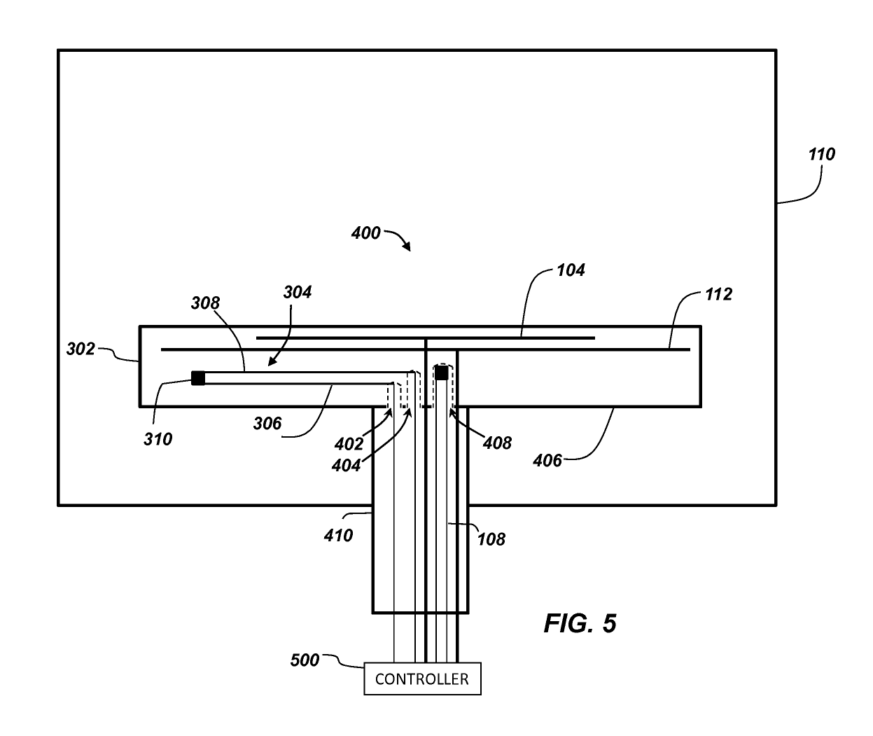

Turning now to FIG. 5, the multi-zone heater pedestal heater 400 of FIG. 4 is depicted within a processing chamber the proper orientation for supporting substrates during electronic device manufacturing processing. Note that the connectors from the thermocouples 108, 304 and heating elements 104, 112 are coupled to a controller 500 which may include a processor and appropriate circuitry adapted to both receive and record signals from the thermocouples 108, 304 and to apply current to the heating elements 104, 112.

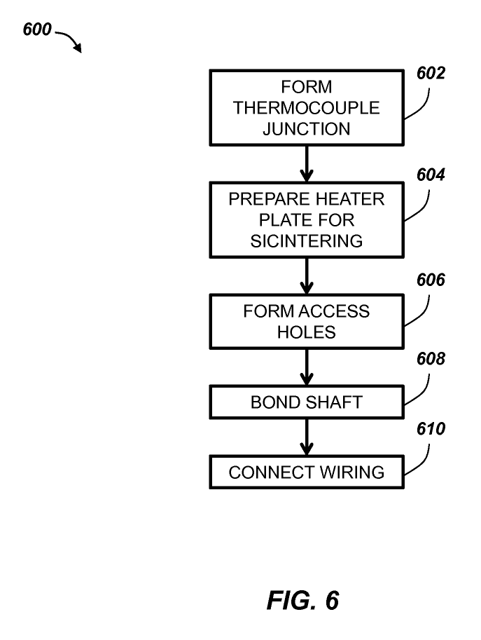

FIG. 6 is a flowchart illustrating an example embodiment of a method 600 of manufacturing a multi-zone pedestal heater according to the present invention. In Step 602, as described in detail above with respect to FIG. 3, a thermocouple is formed from two longitudinal pieces 306, 308 of materials meeting three criteria: (1) a melting point high enough to not be damaged during the manufacturing process; (2) Seebeck coefficient difference sufficient to generate a voltage signal corresponding to small temperature variations that effect semiconductor manufacturing processes; and (3) a coefficient of thermal expansion close enough to the coefficient of thermal expansion of the heater plate so that neither the heater plate nor the thermocouple are damaged due to expansion when exposed to process temperatures.

In Step 604, the heater plate 302 may be formed by layering AlN powder into a sintering mold, positioning the first heating element 104 on the first layer of AlN, depositing a second layer of AlN powder over the first heating element 104, positioning the second heating element 112 on the second layer of AlN powder, adding a third layer of AlN powder over the second heating element 112, positioning the thermocouple 304 on the third layer of AlN, and then depositing a fourth layer of AlN powder over the thermocouple 304. Once the layers of AlN powder, the elements 104, 112, and the thermocouple 304 are in place, high pressure and high temperature (as are known in the art) may be applied to the structure to induce sintering. The result is the formation of a solid heating plate 302 as shown in FIG. 3. Note that the above example describes steps for forming a two zone heater plate. In other embodiments, 3, 4, 5, and 6 or more zone heater plates may be made with appropriate corresponding layering steps and additional heating elements and thermocouples.

In Step 606, after sintering the heater plate 302, access holes 402, 404 are opened in the center of the lower surface 406 of the plate 302. In Step 608, the shaft 410 is bonded to the heater plate 302. In Step 610, the connectors to the thermocouples 108, 304 and heater elements 104, 112 are coupled the respective features. The above method is merely provided as an illustrative example. Note that many additional and alternative steps may be included and that the order of the steps may be altered. Note also that the above steps may include any number of sub-steps or may be combined into fewer total steps.

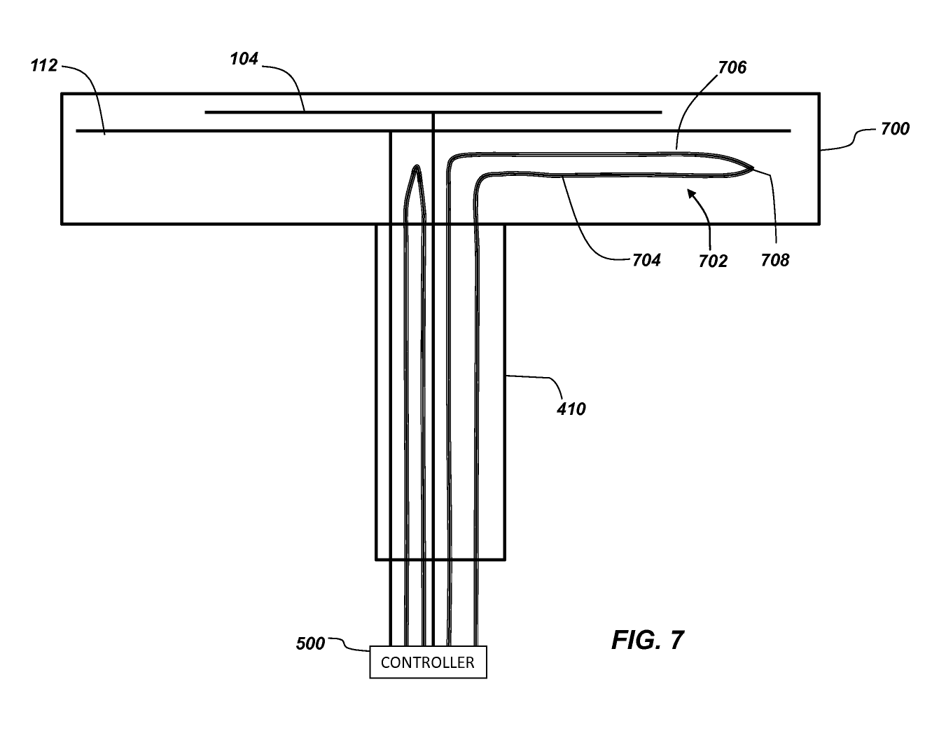

FIG. 7 depicts an alternative embodiment of the present invention. Reference numerals repeated from prior drawings indicate similar elements as those described above. A heater plate 700 with an embedded thermocouple 702 can be fabricated into a brazed metal pedestal heater assembly using insulted wires 704, 706 made of different materials welded together to form a thermocouple junction 708. Similar to the above described embodiments, the different materials of the insulted wires 704, 706 are chosen such that the thermal expansion rates are comparable to that of the heater plate 700. The melting points of the insulted wires 704, 706 including the insulation are higher than the brazing temperature. The Seebeck coefficient difference of the different materials of the insulted wires 704, 706 is sufficient to be able to detect (e.g., generate a perceptible voltage signal) any heater plate 702 temperature variation significant to semiconductor processing (e.g., that could interfere with semiconductor processing). For example, W5Re and W26Re insulted wire may be used as insulted wires 704, 706.

Persons of ordinary skill in the art will understand that alternative memory cells in accordance with this invention may be fabricated using other similar techniques.

The foregoing description discloses only exemplary embodiments of the invention. Modifications of the above disclosed apparatus and methods which fall within the scope of the invention will be readily apparent to those of ordinary skill in the art.

Accordingly, although the present invention has been disclosed in connection with some specific exemplary embodiments thereof, it should be understood that other embodiments may fall within the spirit and scope of the invention, as defined by the following claims.

What is claimed is:

1. A multi-zone pedestal heater for a processing chamber comprising:
a heater plate including:
a first zone including a first heating element and a first thermocouple for sensing the temperature of the first zone wherein the first zone is disposed in the center of the heater plate; and
a second zone including a second heating element and a first embedded thermocouple for sensing the temperature of the second zone wherein the first embedded thermocouple includes a first longitudinal piece that extends from a center of the heater plate to the second zone and the first longitudinal piece is entirely encased within the heater plate.

2. The multi-zone pedestal heater of claim 1 wherein the heater plate further comprises:
a third zone including a third heating element and a second embedded thermocouple for sensing the temperature of the third zone wherein the second embedded thermocouple includes a second longitudinal piece that extends from a center of the heater plate to the third zone and the second longitudinal piece is entirely encased within the heater plate.

3. The multi-zone pedestal heater of claim 1 wherein the first longitudinal piece includes two different longitudinal pieces of materials and wherein the materials have a Seebeck coefficient difference sufficient to generate a voltage signal representative of a heater plate temperature variation sufficient to impact semiconductor processing.

4. The multi-zone pedestal heater of claim 1 wherein the first longitudinal piece includes two different longitudinal pieces of materials and wherein the materials have a melting point greater than a sintering process temperature used to form the heating plate.

5. The multi-zone pedestal heater of claim 1 wherein the first longitudinal piece includes two different longitudinal pieces of materials and wherein the materials have a thermal expansion rate approximately equal to the thermal expansion rate of the heater plate.

6. The multi-zone pedestal heater of claim 1 wherein the first longitudinal piece includes two different longitudinal pieces of materials and wherein the materials include tungsten-5% rhenium alloy (W5Re) and tungsten-26% rhenium alloy (W26Re).

7. The multi-zone pedestal heater of claim 1 wherein the first longitudinal piece includes two different longitudinal pieces of materials,
wherein the materials have a Seebeck coefficient difference sufficient to generate a voltage signal representative of a heater plate temperature variation sufficient to impact semiconductor processing,
wherein the materials have a melting point greater than a sintering process temperature used to form the heating plate, and
wherein the materials have a thermal expansion rate approximately equal to the thermal expansion rate of the heater plate.

8. A multi-zone heater plate for a pedestal heater useable in a semiconductor processing chamber, the heater plate comprising:
a first zone including a first heating element and a first thermocouple for sensing the temperature of the first zone wherein the first zone is disposed in the center of the heater plate; and
a second zone including a second heating element and a first embedded thermocouple for sensing the temperature of the second zone wherein the first embedded thermocouple includes a first longitudinal piece that extends from a center of the heater plate to the second zone and the first longitudinal piece is entirely encased within the heater plate.

9. The multi-zone heater plate of claim 8 further comprising a third zone including a third heating element and a second embedded thermocouple for sensing the temperature of the third zone wherein the second embedded thermocouple includes a second longitudinal piece that extends from a center of the heater plate to the third zone and the second longitudinal piece is entirely encased within the heater plate.

10. The multi-zone heater plate of claim 8 wherein the first longitudinal piece includes two different longitudinal pieces of materials and wherein the materials have a Seebeck coefficient difference sufficient to generate a voltage signal representative of a heater plate temperature variation sufficient to impact semiconductor processing.

11. The multi-zone heater plate of claim 8 wherein the first longitudinal piece includes two different longitudinal pieces of materials and wherein the materials have a melting point greater than a sintering process temperature used to form the heating plate.

12. The multi-zone heater plate of claim 8 wherein the first longitudinal piece includes two different longitudinal pieces of materials and wherein the materials have a thermal expansion rate approximately equal to the thermal expansion rate of the heater plate.

13. The multi-zone heater plate of claim 8 wherein the first longitudinal piece includes two different longitudinal pieces of materials and wherein the materials include tungsten-5% rhenium alloy (W5Re) and tungsten-26% rhenium alloy (W26Re).

14. The multi-zone heater plate of claim 8 wherein the first longitudinal piece includes two different longitudinal pieces of materials,
wherein the materials have a Seebeck coefficient difference sufficient to generate a voltage signal representative of a heater plate temperature variation sufficient to impact semiconductor processing,
wherein the materials have a melting point greater than a sintering process temperature used to form the heating plate, and
wherein the materials have a thermal expansion rate approximately equal to the thermal expansion rate of the heater plate.

15. A method of manufacturing a multi-zone pedestal heater for a processing chamber comprising:
forming a heater plate including:
a first zone including a first heating element and a first thermocouple for sensing the temperature of the first zone wherein the first zone is disposed in the center of the heater plate; and
a second zone including a second heating element and a first embedded thermocouple for sensing the temperature of the second zone wherein the first embedded thermocouple includes a first longitudinal piece that extends from a center of the heater plate to the second zone and the first longitudinal piece is entirely encased within the heater plate.

16. The method of claim 15 wherein forming a heater plate includes forming a heater plate further comprising a third zone including a third heating element and a second embedded thermocouple for sensing the temperature of the third zone wherein the second embedded thermocouple includes a second longitudinal piece that extends from a center of the heater plate to the third zone and the second longitudinal piece is entirely encased within the heater plate.

17. The method of claim 15 wherein the first longitudinal piece includes two different longitudinal pieces of materials and wherein the materials have a Seebeck coefficient difference sufficient to generate a voltage signal representative of a heater plate temperature variation sufficient to impact semiconductor processing.

18. The method of claim 15 wherein the first longitudinal piece includes two different longitudinal pieces of materials and wherein the materials have a melting point greater than a sintering process temperature used to form the heating plate.

19. The method of claim 15 wherein the first longitudinal piece includes two different longitudinal pieces of materials and wherein the materials have a thermal expansion rate approximately equal to the thermal expansion rate of the heater plate.

20. The method of claim 15 wherein the first longitudinal piece includes two different longitudinal pieces of materials and wherein the materials include tungsten-5% rhenium alloy (W5Re) and tungsten-26% rhenium alloy (W26Re).
